(19) United States
(12) Patent Application Publication
(10) Pub. No.: US 2014/0167502 A1
(43) Pub. Date: Jun. 19, 2014

(54) Converter device and method of converting power

(71) Applicant: James T. Lopez, Dallas, TX (US)

(72) Inventor: James T. Lopez, Dallas, TX (US)

(73) Assignee: Estill Medical Technologies, Inc., Dallas, TX (US)

(21) Appl. No.: 13/998,826

(22) Filed: Dec. 11, 2013

Related U.S. Application Data
(60) Provisional application No. 61/797,767, filed on Dec. 14, 2012.

(51) Int. Cl. H02J 4/00

(52) U.S. Cl. CPC H02J 4/00
USPC 307/18

(57) ABSTRACT

A power converter having a multiple power inputs and multiple power outputs. More specifically, the power converter has a first power input that is a rail system having power contacts for engaging a first battery wherein the first battery has complimentary rail receiving means and power contacts for engaging the rail system. A second power input is also available for receiving a cable from a second battery. A third power input is also available for engaging with a box type lithium battery. The converter has multiple power outputs including a first power output for engaging with and powering a box type lithium battery, a female cigarette lighter output for engaging and powering devices that are powered by cigarette lighter type power connections, a USB output for engaging and powering USB devices and a 2.5 mm wire and plug for engaging and powering devices powered by 2.5 mm wire and plug connection. The converter is capable of using the multiple inputs to power the multiple outputs. Likewise the multiple inputs can also power the other multiple input batteries.

This is a non-provisional application claiming priority under 35 USC 119(e) of provisional application Ser. No. 61/797,767, filed Dec. 14, 2012.

### BACKGROUND OF THE INVENTION

1. Field of the Invention

The invention relates to a power converter apparatus. More particularly, the invention relates to a power converter apparatus that is capable of powering and charging various batteries and devices.

2. Brief Description of Related Art

The object of the present invention is to provide a power converter that is capable of taking multiple input power sources and converting them into a multitude of defined output sources capable of powering and charging various devices. The power converter of the invention can easily charge a battery for heating a fluid warming device. The power converter is portable, lightweight and can be used to provide power to a multitude of different devices using commercial batteries as the power source or a 5590/2590 standard military battery as the power source or other suitable battery.

### SUMMARY OF THE INVENTION

A power converter having a multiple power inputs and multiple power outputs. More specifically, the power converter has a first power input that is a rail system having power contacts for engaging a first battery wherein the first battery has complimentary rail receiving means and power contacts for engaging the rail system. A second power input is also available for receiving a cable from a second battery. A third power input is also available for engaging with a box type lithium battery. The converter has multiple power outputs including a first power output for engaging with and powering a box type lithium battery, a female cigarette lighter output for engaging and powering devices that are powered by cigarette lighter type power connections, a USB output for engaging and powering USB devices and a 2.5 mm wire and plug for engaging and powering devices powered by 2.5 mm wire and plug connection. The converter is capable of using the multiple inputs to power the multiple outputs. Likewise the multiple inputs can also power the other multiple input batteries.

### BRIEF DESCRIPTION OF THE FIGURES

FIG. 1 is a left side view of the converter of the present invention;

FIG. 2 is a right side top view the converter of the present invention;

FIG. 3a is a perspective view of the converter of the invention showing how the converter interfaces with other devices (with expanded end-face on the right side);

FIG. 3b is an end view of the converter shown in FIG. 3a;

FIG. 4 is a block diagram showing how the converter of the present invention interfaces with various inputs and outputs;

FIG. 5 is a flow diagram showing the direction of power and circuitry;

FIG. 6 is a flow diagram of the inputs and outputs of the present invention; and

FIG. 7 is a flow diagram of the circuitry of the present invention.

### DETAILED DESCRIPTION

The present invention is directed to a power converter 100 for powering various devices from different power sources. The converter has a housing 10 enclosing the electronics for converting various power inputs into various power outputs as desired by a user. The housing 10 provides openings in the form of outlets and inlets for accessing the converter 100. The openings permit inputs of power and outputs of power. The inputs provide power, which is converted to outputs of power to devices that require power to operate.

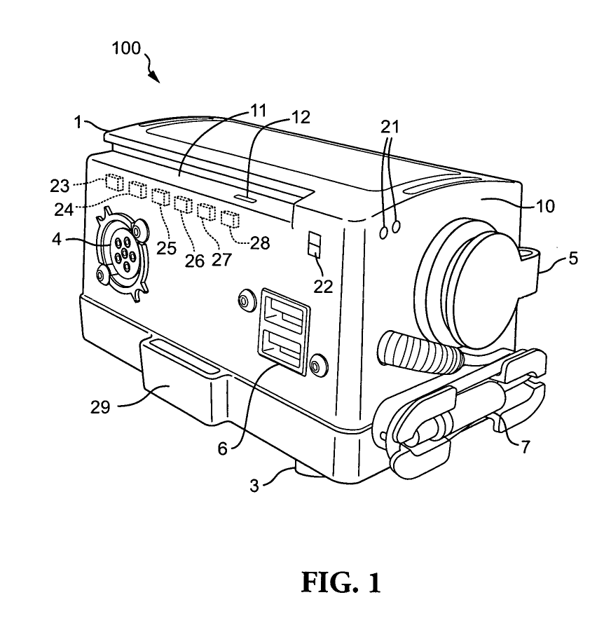

As shown in FIG. 1, housing 10 encloses internal converter circuitry (not shown). On the external faces of the outside walls of the converter are openings for inputs and outputs.

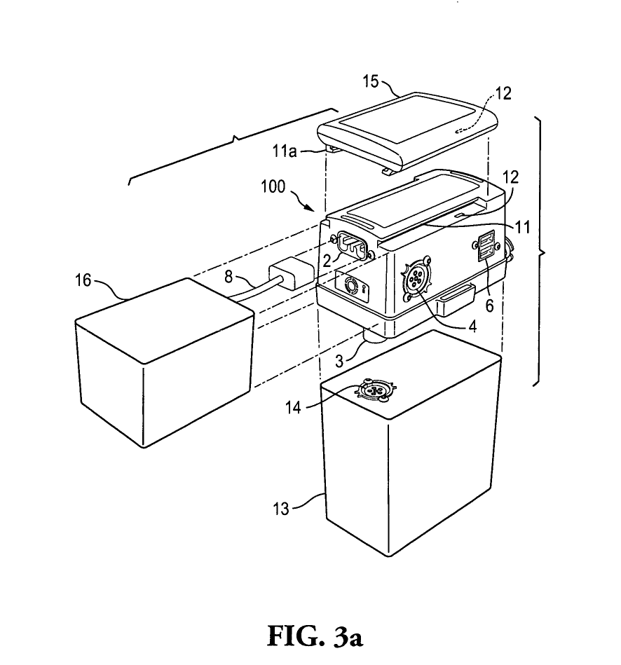

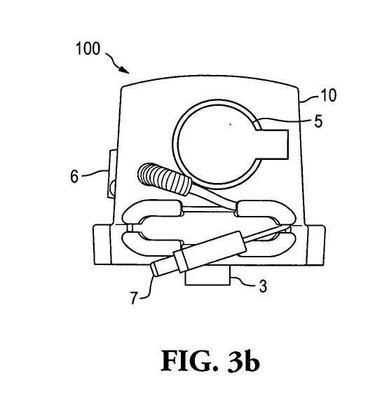

There are basically three types of power inputs for the converter of the invention. The first power input is a rail system input 1. The rails 11 of the rail system input 1 receive complimentary rails of a first 9.0 Vdc to 36.0 Vdc battery 15. A user simply slides a first 9.0 Vdc to 36 Vdc battery 15 with complimentary rails 11a (FIG. 3) onto the rails 11 of the converter, thereby engaging power contacts 12 on the converter with complimentary power contacts 12 on the first 9.0 Vdc to 36 Vdc battery 15. While engaged, the first 9.0 Vdc to 36 Vdc battery can provide power to the converter. It is also possible that the first 9.0 Vdc to 36 Vdc battery 15 may also be charged while engaged if an additional power source is connected to the converter 100 at the same time. The rail system may also receive a battery with complimentary rails from a lithium battery.

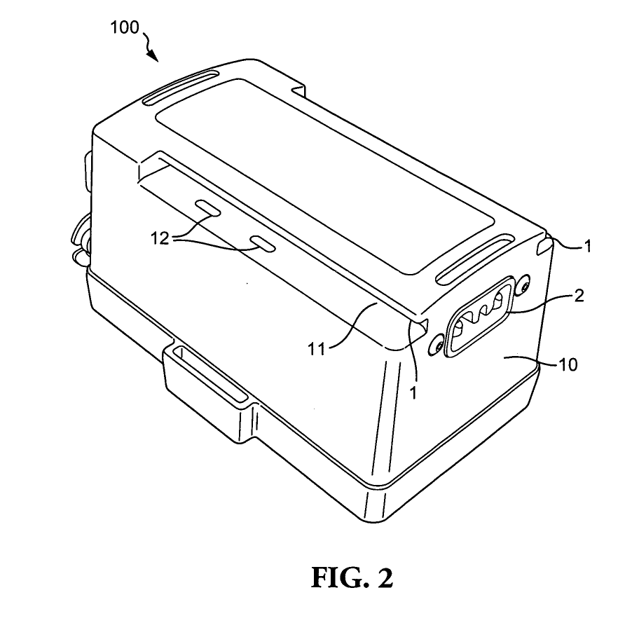

A second power input 2 for the converter 100 is shown on in FIG. 2. The second power input receives a cable 8 that is attached to a second 9.0 Vdc to 36.0 Vdc battery 16 (FIG. 3). In this configuration, the second battery 16 provides power to the converter 100 for powering external devices, such as the first battery 15 or additional types of devices that are electrically hooked up to or connected to the converter.

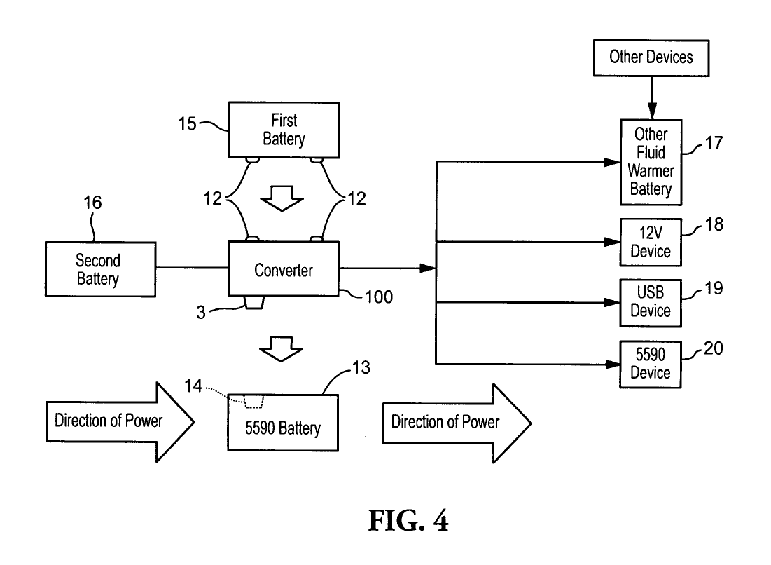

The third power input 3 is a male 5590/2590 input. This input permits the converter 100 to be connected via a male input to a standard 5590/2590 lithium battery 13 (FIGS. 3a, 3b and 4). The lithium battery 13 provides power through the converter that can be transferred to the first battery 15, second battery 16 or a multitude of other power devices that can be connected to the converter. The male 5590/2590 input 3 is received by a female receptacle 14 in the 5590/2590 battery 13.

FIGS. 1-4 show multiple power outputs from the converter 100. The first power output is a female 5590/2590 jack 4, as shown in FIGS. 1, 2, 3a, 3b and 5. This permits the converter 100 to connect to devices that are compatible with a 5590/2590 lithium battery. Strap receiving means 29, shown in FIG. 1 can be used to strap a 5590/2590 battery to the converter if desired.

The second power output is a female cigarette lighter type output 5. This allows the converter 100 to power devices that normally are powered by a male version of a 12 volt cigarette lighter plug.

The third power output is a USB output 6 that allows the converter 100 to charge USB items such as an iPhone®, Blackberry®, etc.

As shown in FIG. 3b, the fourth power output is a 2.5 mm wire and plug 7 for electrically charging a fluid warmer battery and powering other devices with a 2.5 mm power jack receptacle.

If the converter 100 is connected to the 5590/2590 battery 13, first battery 15, or second battery 16, the converter is capable of providing power through any one of outputs 4, 5, 6 or 7 to multiple power devices.

Special attention is made to isolate the various input power sources and sequence the use of the input power sources if multiple sources are attached at the same time. Power is routed in the most energy efficient manor for each output device.

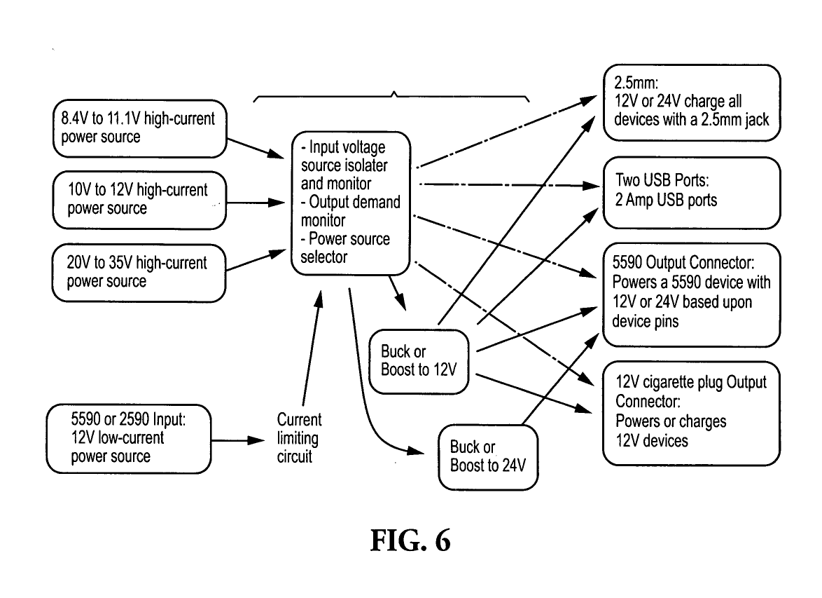

As shown in FIG. 6, the converter 100 uses the power routing protocols as shown. Each input power source must be identified, prioritized, isolated from other sources and then routed to the proper output sources while protecting the source from overload conditions. The simplified diagram depicts the basic required flow from a 10,000 foot level. The dashed arrows are switching hard connections when voltage matchups are available. Their use depends on the input power sources used. The hard connections allow for very efficient operation with minimal energy loss normally found in an energy conversion process. When they are not available, voltage boosting and bucking will be used. A microprocessor can be used to manage various commands and tasks.

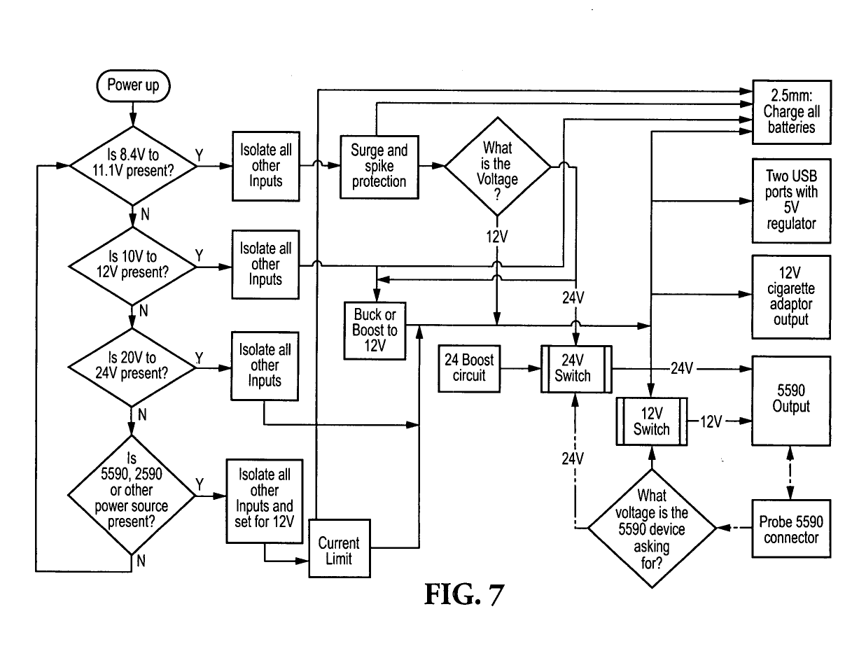

FIG. 7 shows a more detailed flow diagram for the converter 100. Upon power up, the converter will look for the best power source available. It will first look for the 8.4V to 11.1V high-current power source then the 10V to 12V high-current power source, then the 20V to 24V high-current power source and then the 5590 battery or 2590 battery (not shown) in that order. When the converter 100 finds a viable power source that meets a minimum voltage requirement, it will use that source while isolating all other power sources that are attached. Once the source is depleted, it will look for the next best source, and start routing its power to the output devices as needed. This will continue until all input power sources have been exhausted.

Depending on the voltage of the power source, it will be routed directly to the output device as hard connection maximizing the energy transfer process. Some outputs are always buffered because of their voltage requirements. The USB ports are an example of this.

The 8.4V to 11.1V battery 15 input will always be boosted since its output can fall below the operating voltage of many of the outputs.

The 5590 battery 13 and 2590 battery (not shown but may be substituted for the 5590 battery 13) input power sources will be current limited, so if output devices are demanding excessive power from it, they won't cause the internal battery fuses to blow. The invention establishes output priorities to determine which outputs will shed power as needed to protect the 5590 battery 13 and 2590 battery. This can be by user selection or by programmed algorithm.

LEDs (light emitting diode) can be used to show which outputs are available and which outputs have been load shedder. Load shedding, is an intentionally engineered electrical power shutdown where electricity delivery is stopped for non-overlapping periods of time over different parts of the distribution region. An example might be attaching a high-power spotlight to the 12V cigarette lighter output that draws 15 Amps. If the 5590 battery was the only input power source available, the circuitry will realize the 5590 fuses will blow with this excessive load. The outlet will be turned off to protect the battery, and a LED can light showing it's been disabled. If the second battery 16 is attached, the output will be reactivated and the LED will turn off, and the high-power spotlight will turn on. This methodology makes the converter 100 very robust and easy to use, while preventing damage or misuse.

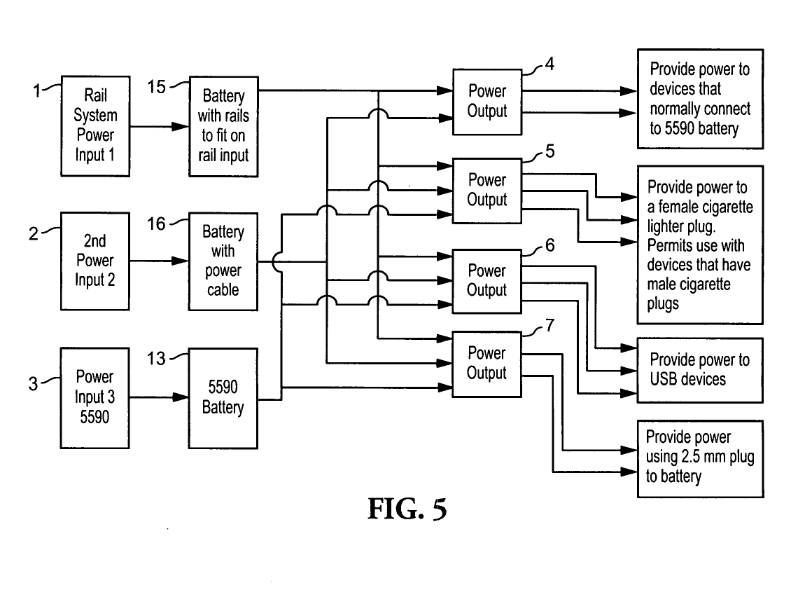

The converter uses standard mechanical interfaces, power switching, boost circuits, buck circuits, surge and spike protection ware, switches, current limiting circuits, USB circuits and LED functions as are known in the art. Power cables are used in some cases to connect batteries to the converter. This is shown in FIG. 5 connecting the second battery 16 to the second power input 2. Power cables also connect the converter 100 between the outputs 4-7 and power devices 17-20 (FIG. 4).

It should be recognized that different types of power cables using different types of connections, i.e. plug ends, may be used in the invention or substituted in the design of the housing as long as they are compatible with the battery source. More specifically, the second power input receptacle 2 can be of any shape as long as it receives a desired power cable from a desired power source such as a battery. Further, the shape of the rails may be changed as long as they perform the desired connection of the power contacts 12 on the first battery 15 contact the power contacts 12 on the rail system power input 1. The use of different designs of cables, connections or power contacts does not depart from the spirit of the invention.

The housing may be plastic, metal or any durable and hard material. The batteries are preferably lithium ion batteries or lithium polymer batteries. Other batteries may also be used.

The invention also relates to a system of conversation of energy that includes some or all of the elements shown in FIGS. 3a and 3b. The system includes the converter of the invention, multiple batteries, as described, and multiple output cables and cabling or attachments.

The invention is also directed to a method of converting power from various sources using the converter of the invention and directing the power to supply power to various types of devices as disclosed.

### EXAMPLES

Having generally described this invention, a further understanding can be obtained by reference to certain specific examples, which are provided herein for purposes of illustration only and are not intended to be limiting unless otherwise specified.

### Example 1

A power conversion system or kit is made by assembling in association together the above described power converter and one or more batteries, one or more input cables, and one or more output cables.

### Example 2

A method of converting power is accomplished with the power converter of the invention by 1) attaching the power converter to one or more power input sources, 2) attaching the converter to one or more power output sources, 3) supplying power from one of the power input source to one of the power output source.

### Example 3

A method of converting power to charge a battery (power input source) is accomplished with the power converter of the invention by 1) attaching the power converter to one or more power input sources, 2) attaching the converter to one or more power input sources, or batteries 3) supplying power from one of the power input sources to charge one of the power input sources or batteries with the one or more other power input sources.

Definitions:

A 5590 battery is the most common box type battery used by the military in the field. This battery is rated at 7.2 Ah at 70 0 F and 5.6 Ah at −20 0 F. Based on the Li/SO2 chemistry, in use the US Military in communications applications over the past 10-15 years, this type was the only lithium technology currently available that has a proven successful record in combat situations. With a nominal 200 mA drain in typical use, the battery could provide 28 hours of operation at the minimum temperature.

A 5590 device is any device powered by a 5590 battery.

The 2590 battery is a box type military lithium ion battery having the following specifications: Maximum Voltage: 33V, Two (2) 16.5 V Section, Nominal Voltage: 28.8V, Two (2) 14.4 V Section, Nominal Capacity: 6.2 Ah@28.8 V—12.4, Cutoff Voltage: 20.0V—10.0, Operating Temperature Range: −20 C to +55 C (−4 F to +131 F), Storage Temperature Range: −20 C to +55 C (−4 F to +131 F), Exterior/Housing: Hard plastic, black (Noryl N190X-701), State of Charge: LCD display (Does Not Include SMBus), Connector: Floating Type Per U.S. Army DWG#SC-C-179495, Standard Charge: Charge each section independently at constant voltage of 16.5V 3 A (max) for 5 Hr., −Discharge: <5% per Month.

A 2950 device is any device powered by a 2590 battery.

Lithium type batteries include Sulfur Dioxide (LiSO2), Lithium Manganese (LiMn), Lithium Ion (Li-Ion), and Lithium polymer. Lithium based batteries are used throughout the Department of Defense in numerous weapons and communication systems.

Universal Serial Bus (USB) is an industry standard developed in the mid-1990s that defines the cables, connectors and communications protocols used in a bus for connection, communication, and power supply between computers and electronic devices.

A USB device is any device powered by a USB cable or connector.

A 12 Volt device is any device powered by 12 volts of current.

A lithium device is any device powered by a lithium battery.

A 2.5 mm device is any device powered by a 2.5 mm wire electrical connector and having a 2.5 mm power jack receptacle.

Fluid warmer is a device that warms blood or other fluids that are to be distributed to a patient. A fluid warmer battery is a battery that powers a fluid warmer. An example of a fluid warmer battery is the rail type battery described herein.

Having now fully described the invention, it will be apparent to one of ordinary skill in the art that many changes and modifications can be made thereto without departing from the spirit or scope of the invention as set for the herein.

What is claimed is:

1. A power converter having multiple inputs and multiple outputs for being charged by, charging and powering various devices, said devices having multiple amounts of voltage or voltage requirements.

2. A power converter of claim 1, wherein said various devices include batteries selected from lithium batteries and/or direct current batteries.

3. The power converter of claim 2, wherein said lithium and/or direct current batteries comprise: rail type battery or box type battery.

4. The power converter of claim 3, wherein said rail type battery is a 9 v-36 vdc battery.

5. The power converter of claim 3, wherein said box type battery is a 5590/2590 lithium battery.

6. The power converter of claim 1, wherein said device includes multiple power outputs comprising: a 5590/2590 jack output, 12V female cigarette lighter type output, USB output and 2.5 mm wire and plug output.

7. The power converter of claim 6, wherein said power outputs power one or more power receiving devices selected from fluid warmer battery, 12 Volt device, USB device, 5590/2590 device and 2.5 mm power jack receiving device.

8. The power converter of claim 1, wherein said converter has one or more of the following: standard mechanical interfaces, power switching, boost circuits, buck circuits, surge and spike protection ware, switches, current limiting circuits, USB circuits and LED functions.

9. The power converter of claim 1, wherein said converter is capable of determining and using a best power source connected and available thereto to power a power receiving device or to charge a battery connected thereto.

10. The power converter of claim 1, wherein said converter is capable of finding and selecting a viable power source connected thereto, via one of said multiple inputs, that meets a minimum voltage requirement for a power receiving device connected thereto via one of said outputs, and using the viable power source while isolating all other power sources, and wherein once the viable power source is depleted, the converter determines and uses a next best power source connected thereto and routes power through said output to said power receiving device.

11. The power converter of claim 10, wherein said routing is accomplished with power routing protocols.

12. The power converter of claim 1, wherein some of said outputs are buffered.

13. The power converter of claim 1, wherein some of said inputs are boosted.

14. The power converter of claim 1, wherein said converter mah limit current from power input sources.

15. The power converter of claim 1, wherein said converter contains output priorities to determine which outputs will shed power as needed to protect a power input source.

16. A power converter for charging multiple types of power devices; said power converter comprising:
multiple power inputs from both lithium batteries and DC batteries; and
multiple different types of power outputs for powering different types of power receiving devices.

17. A power converter comprising:
a. a first power input comprising a rail system having power contacts for engaging a first battery, said first battery having complimentary rail receiving means and power contacts for engaging said rail system;
b. a second power input for receiving a cable from a second battery;
c. a third power input for engaging with a third battery comprising a box type lithium battery;
d. a first power output for engaging with and powering a box type lithium battery;
e. a second power output comprising a female cigarette lighter output for engaging and powering devices that are powered by cigarette lighter type power connections;
f. a forth power output comprising a USB output for engaging and powering USB devices;
g. a fifth power output comprising a wire and plug for engaging and powering devices powered by wire and plug connection; wherein
said converter is capable of using said multiple inputs to power said multiple outputs; and wherein said multiple inputs can power said other multiple input batteries.

18. The power converter of claim 17, wherein said first and second power inputs receive power from lithium type batteries.

19. The power converter of claim 17, wherein said wire and plug connections are 2.5 mm wire plugs and connections.

20. A power conversion system or kit comprising the power converter of claim 1 and one or more batteries, one or more input cables, and one or more output cables.

21. The invention is also directed to a method of converting power from various sources comprising: 1) attaching the converter of claim 1 to one or more power input sources, 2) attaching the converter to one or more power output sources, 3) supplying power from said one of said power input source to one of said power output source and/or charging one or more of said power input sources with another of said power input sources.
